(19) United States
(12) Patent Application Publication
(10) Pub. No.: US 2022/0239207 A1
(43) Pub. Date: Jul. 28, 2022

(54) ROTARY MOTOR AND ROBOT

(71) Applicant: SEIKO EPSON CORPORATION, Tokyo (JP)

(72) Inventors: Hideaki NISHIDA, SUWA-SHI (JP); Kuniaki TANAKA, MATSUMOTO-SHI (JP); Shigekazu TAKAGI, SHIOJIRI-SHI (JP); Hiroshi KOEDA, SUWA-SHI (JP); Hiroshi WADA, AZUMINO-SHI (JP)

(21) Appl. No.: 17/584,411

(22) Filed: Jan. 26, 2022

(30) Foreign Application Priority Data
Jan. 27, 2021 (JP) 2021-010892

(51) Int. Cl. H02K 21/24; B25J 9/12

(52) U.S. Cl. CPC H02K 21/24; B25J 9/126

(57) ABSTRACT

A lower part first main magnet, a lower part first sub-magnet, a lower part second main magnet, and a lower part second sub-magnet of a motor are sequentially repeatedly placed along a circumference of a rotation axis for relative rotation, a magnetization direction of the lower part first main magnet is a lower part first direction, a magnetization direction of the lower part second main magnet is a lower part second direction, magnetization directions of the lower part first sub-magnet and the lower part second sub-magnet are circumferential directions, the lower part first sub-magnet and the lower part second sub-magnet have recessed portions in parts facing a first stator and facing the lower part first main magnet or the lower part second main magnet, and lower part first auxiliary magnet to lower part fourth auxiliary magnet in magnetization directions different from the lower part first direction.

The present application is based on, and claims priority from JP Application Serial Number 2021-010892, filed Jan. 27, 2021, the disclosure of which is hereby incorporated by reference herein in its entirety.

### BACKGROUND

### 1. Technical Field

The present disclosure relates to a rotary motor and a robot.

### 2. Related Art

JP-A-2004-072820 discloses a radial gap motor in a Halbach array. According to the motor, a rotor includes a first sub-pole magnet in a magnetization direction along a circumferential direction between a first main pole magnet in a magnetization direction toward a rotation axis and a second main pole magnet in a magnetization direction toward a stator. The rotor includes a second sub-pole magnet in a magnetization direction inclined at 45 degrees relative to the circumferential direction between the first main pole magnet and the first sub-pole magnet. The rotor includes a third sub-pole magnet in a magnetization direction inclined at 45 degrees relative to the circumferential direction between the second main pole magnet and the first sub-pole magnet.

The magnetization direction of the second sub-pole magnet is an intermediate direction between the first main pole magnet and the first sub-pole magnet. The magnetization direction of the third sub-pole magnet is an intermediate direction between the second main pole magnet and the first sub-pole magnet. The first main pole magnet, the second sub-pole magnet, the first sub-pole magnet, the third sub-pole magnet, and the second main pole magnet are sequentially placed to form a magnetic circuit.

However, in the motor of JP-A-2004-072820, when the rotor rotates, a magnetic field where intensity transitions in a sinusoidal wave form acts on the magnets by the stator, and there is a problem that part of the sub-pole magnets is demagnetized. When demagnetized, magnetic characteristics are deteriorated and torque is lower.

### SUMMARY

A rotary motor includes a stator, and a rotor rotating relative to the stator, wherein the rotor has a first main pole magnet, a first sub-pole magnet, a second main pole magnet, and a second sub-pole magnet in contact with one another, the first main pole magnet, the first sub-pole magnet, the second main pole magnet, and the second sub-pole magnet are sequentially repeatedly placed along a circumference of a rotation axis for relative rotation, a magnetization direction of the first main pole magnet is a first direction from the stator toward the rotor, a magnetization direction of the second main pole magnet is a second direction from the rotor toward the stator, magnetization directions of the first sub-pole magnet and the second sub-pole magnet are circumferential directions from the first main pole magnet toward the second main pole magnet, the first sub-pole magnet and the second sub-pole magnet have recessed portions in parts facing the stator and facing the first main pole magnet or the second main pole magnet, and third magnets in magnetization directions different from the first direction, the second direction, or the circumferential directions or fillers containing a magnetic material are provided in the recessed portions.

A robot includes the above described rotary motor.

### BRIEF DESCRIPTION OF THE DRAWINGS

FIG. 1 is a schematic side sectional view showing an overall configuration of a rotary motor according to a first embodiment.

FIG. 2 is a schematic plan view of a main part showing a configuration of a rotor.

FIG. 3 is a schematic side view of a main part for explanation of a configuration of a magnet.

FIG. 4 is a schematic side view of a main part for explanation of a configuration of a magnet according to a second embodiment.

FIG. 5 is a schematic side view of a main part for explanation of a configuration of a magnet according to a third embodiment.

FIG. 6 is a schematic side view of a main part for explanation of a configuration of a magnet according to a fourth embodiment.

FIG. 7 is a schematic side view of a main part for explanation of a configuration of a magnet according to a fifth embodiment.

FIG. 8 is a schematic side view of a main part for explanation of a configuration of a magnet according to a sixth embodiment.

FIG. 9 is a schematic side view of a main part for explanation of a configuration of a magnet according to a seventh embodiment.

FIG. 10 is a schematic side view of a main part for explanation of a configuration of a magnet according to an eighth embodiment.

FIG. 11 is a schematic plan view of a main part for explanation of a configuration of a magnet according to a ninth embodiment.

FIG. 12 is a schematic perspective view showing a configuration of a robot according to a tenth embodiment.

FIG. 13 is a schematic side view of a main part for explanation of a configuration of a magnet according to a related art.

### DESCRIPTION OF EXEMPLARY EMBODIMENTS

### First Embodiment

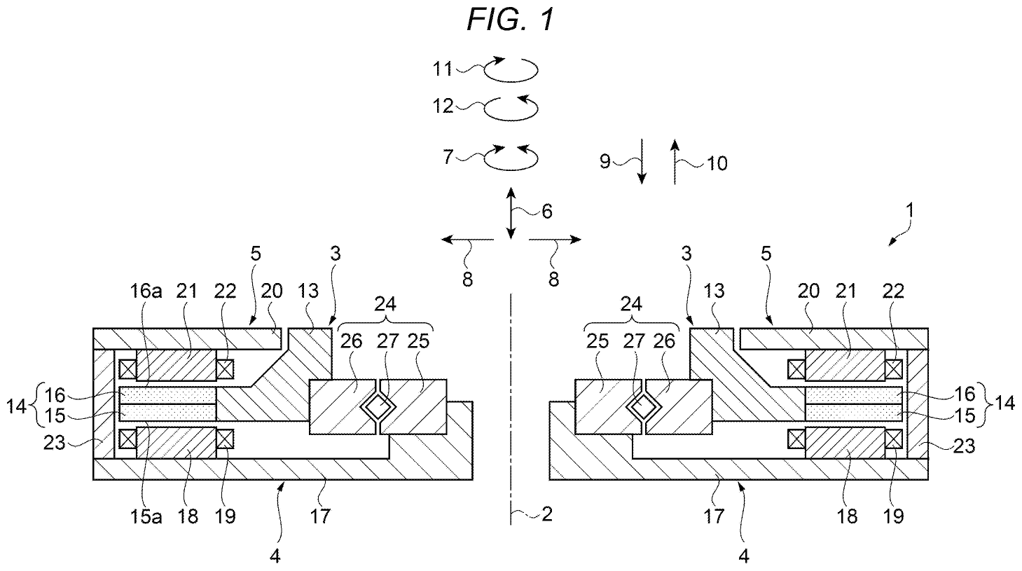

A motor 1 as a rotary motor shown in FIG. 1 is an axial gap motor employing a double-stator structure. The motor 1 includes a rotor 3 having an annular shape rotating around a rotation axis 2, and a first stator 4 as a stator and a second stator 5 as a stator placed with the rotor 3 in between along the rotation axis 2. The rotor 3 rotates relative to the first stator 4 and the second stator 5. The motor 1 rotates the rotor 3 around the rotation axis 2.

Directions along the rotation axis 2 are axial directions 6. Directions along the circumference of the rotor 3 are “circumferential directions 7”. A direction outward along the radius of the rotor 3 is a radial direction 8. A direction from the second stator 5 toward the first stator 4 is a downward direction 9. A direction from the first stator 4 toward the second stator 5 is an upward direction 10. A clockwise direction as seen in the downward direction 9 is a first circumferential direction 11. A counterclockwise direction as seen in the downward direction 9 is a second circumferential direction 12.

The rotor 3 includes a frame 13 and a permanent magnet 14 supported by the frame 13. The permanent magnet 14 is bonded and fixed to a side of the frame 13 in the radial direction 8. The permanent magnet 14 is a magnetized magnet. The permanent magnet 14 includes a lower part permanent magnet 15 and an upper part permanent magnet 16. The lower part permanent magnet 15 and the upper part permanent magnet 16 overlap as seen from the axial directions 6. The lower part permanent magnet 15 and the upper part permanent magnet 16 are bonded and fixed to each other. The lower part permanent magnet 15 is placed at the first stator 4 side and the upper part permanent magnet 16 is placed at the second stator 5 side. A lower surface 15a of the lower part permanent magnet 15 faces the first stator 4 and an upper surface 16a of the upper part permanent magnet 16 faces the second stator 5.

The first stator 4 and the second stator 5 are placed to sandwich the rotor 3 from both sides in the axial directions 6. The first stator 4 is placed in the downward direction 9 of the rotor 3 via a gap. The second stator 5 is placed in the upward direction 10 of the rotor 3 via a gap.

The first stator 4 has a bottom case 17 having an annular shape, a plurality of first stator cores 18, and first coils 19 placed in the respective first stator cores 18. The first stator cores 18 are placed in the upward direction 10 of the bottom case 17. Note that back yokes (not shown) are provided to connect the first stator cores 18 between the plurality of first stator cores 18.

The second stator 5 has a top case 20 having an annular shape, a plurality of second stator cores 21, and second coils 22 placed in the respective second stator cores 21. The second stator cores 21 are placed in the downward direction 9 of the top case 20. Note that back yokes (not shown) are provided to connect the second stator cores 21 between the plurality of second stator cores 21.

Next, the configuration of the first stator 4 will be explained. The first stator 4 and the second stator 5 have the same configuration as each other and, as below, the first stator 4 will be representatively explained and the explanation of the second stator 5 will be omitted.

The constituent material of the bottom case 17 includes e.g. a metal material such as stainless steel, aluminum alloy, magnesium alloy, and titanium alloy, a ceramics material such as alumina and zirconia, and a resin material such as engineering plastic. In addition, the constituent material of the bottom case 17 includes e.g. various fiber-reinforced plastics such as CFRP (Carbon Fiber Reinforced Plastics) and GFRP (Glass Fiber Reinforced Plastics), and fiber-reinforced composite materials such as FRC (Fiber Reinforced Ceramics) and FRM (Fiber Reinforced Metallics).

The constituent material of the bottom case 17 is preferably a non-magnetic material. The bottom case 17 is harder to be affected by magnetic flux and a problem of torque reduction or the like is harder to occur. The non-magnetic material refers to a material having relative magnetic permeability substantially from 0.9 to 3.0.

The first stator 4 has the plurality of first stator cores 18. The first stator cores 18 are arranged at equal intervals along the circumferential directions 7. Each first stator core 18 is formed using e.g. various magnetic materials including a stacking material of magnetic steel sheets and a green compact of magnetic powder, particularly, a soft magnetic material.

The respective first stator cores 18 may be fixed to the bottom case 17 by e.g. melting, adhesives, welding, or the like, or engaged with the bottom case 17 using various engagement structures.

The first coil 19 is wound around the outer circumference of the first stator core 18. The first stator core 18 and the first coil 19 form an electromagnet. The first coil 19 may be a conducting wire wound around the first stator core 18 or a conducting wire is wound around a bobbin or the like in advance and fitted around the outer circumference of the first stator core 18.

The motor 1 has an energizing circuit (not shown) and each first coil 19 is coupled to the energizing circuit. Each first coil 19 is energized with a predetermined cycle or predetermined pattern. For example, when a three-phase alternating current is applied to each first coil 19, magnetic flux is generated from the electromagnet and a force acts on the facing permanent magnet 14. The state is cyclically repeated, and the rotor 3 rotates around the rotation axis 2.

The first stator 4 may be molded using a resin as a whole. By molding using a resin, the bottom case 17 and the first stator cores 18 may be fixed to each other.

The first stator 4 and the second stator 5 are coupled via a center case 23. The center case 23 is located at the outside of the rotor 3 and has a cylindrical shape.

The bottom case 17 and the frame 13 are rotatably coupled via a cross roller bearing 24. The cross roller bearing 24 includes an inner ring 25, an outer ring 26, and a roller 27. The bottom case 17 is coupled to the inner ring 25 and the frame 13 is coupled to the outer ring 26. The inner ring 25 and the outer ring 26 rotate relative to each other via the roller 27. The rotor 3 is rotatably supported relative to the first stator 4 and the second stator 5.

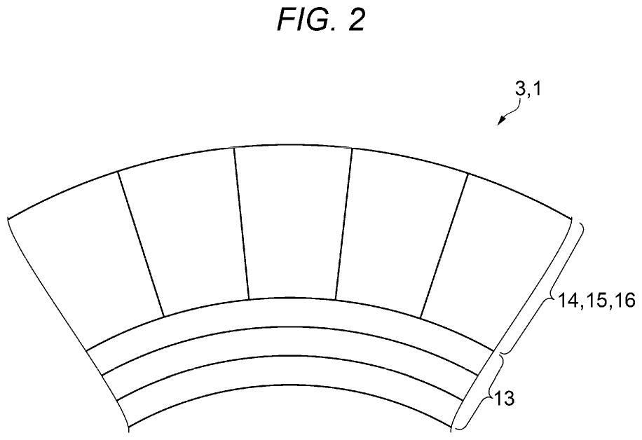

FIG. 2 is a plan view of the rotor 3 as seen in the downward direction 9. A part of the rotor 3 having the annular shape in the circumferential directions 7 is shown in FIG. 2. As shown in FIG. 2, the rotor 3 includes the frame 13 and the permanent magnet 14. The frame 13 has an annular shape. The constituent material of the frame 13 includes e.g. a metal material such as stainless steel, aluminum alloy, magnesium alloy, and titanium alloy, a ceramic material such as alumina and zirconia, and a resin material such as engineering plastic. In addition, the constituent material of the frame 13 includes e.g. various fiber-reinforced plastics such as CFRP (Carbon Fiber Reinforced Plastics) and GFRP (Glass Fiber Reinforced Plastics), and fiber-reinforced composite materials such as FRC (Fiber Reinforced Ceramics) and FRM (Fiber Reinforced Metallics).

The constituent material of the frame 13 is preferably a non-magnetic material. The frame 13 is harder to be affected by magnetic flux and a problem of torque reduction or the like is harder to occur. The non-magnetic material refers to a material having relative magnetic permeability substantially from 0.9 to 3.0.

The permanent magnet 14 includes, but is not limited to e.g. a neodymium magnet, a ferrite magnet, a samarium-cobalt magnet, an alnico magnet, and a bonded magnet.

The permanent magnet 14 is fixed to the frame 13 using e.g. an adhesive, a fastening tool, a binding tool, or the like. Or, both an adhesive and other means may be used. An adhesive or a molding resin may be placed to cover the permanent magnet 14.

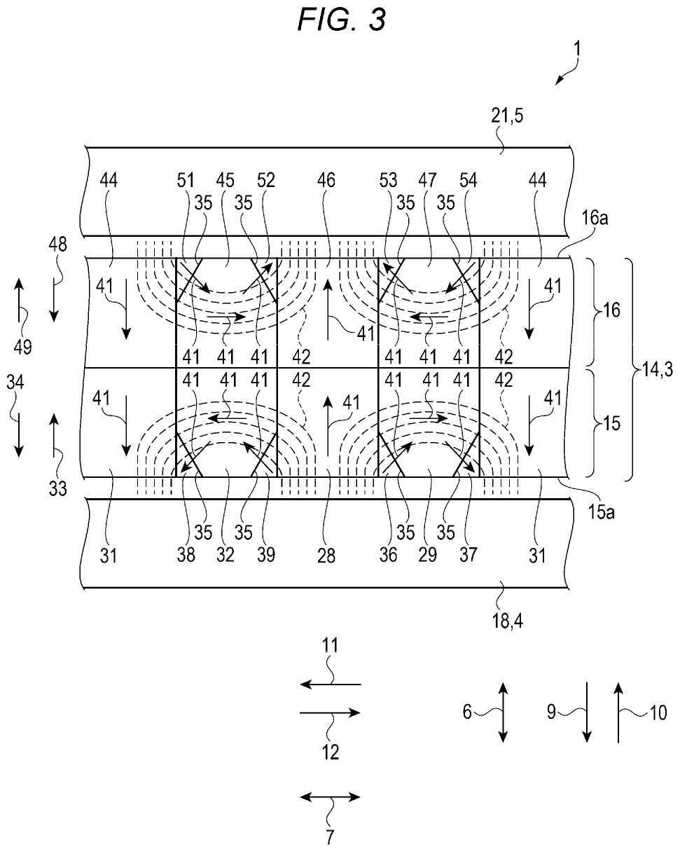

FIG. 3 shows the rotor 3 in FIG. 2 as seen from the opposite direction to the radial direction 8. As shown in FIG. 3, the permanent magnet 14 of the rotor 3 is placed in a Halbach magnet array.

The lower part permanent magnet 15 of the rotor 3 has a lower part first main magnet 28 as a first main pole magnet, a lower part first sub-magnet 29 as a first sub-pole magnet, a lower part second main magnet 31 as a second main pole magnet, and a lower part second sub-magnet 32 as a second sub-pole magnet in contact with one another. The lower part first main magnet 28, the lower part first sub-magnet 29, the lower part second main magnet 31, and the lower part second sub-magnet 32 are sequentially repeatedly placed along the circumference of the rotation axis 2 for relative rotation.

A direction from the first stator core 18 toward the rotor 3 is a lower part first direction 33 as a first direction. A magnetization direction 41 of the lower part first main magnet 28 is the lower part first direction 33. Arrows within the permanent magnet 14 in FIG. 3 show the magnetization directions 41. A direction from the rotor 3 toward the first stator core 18 is a lower part second direction 34 as a second direction. A magnetization direction 41 of the lower part second main magnet 31 is the lower part second direction 34. The magnetization directions 41 of the lower part first sub-magnet 29 and the lower part second sub-magnet 32 are the circumferential directions 7 from the lower part first main magnet 28 toward the lower part second main magnet 31.

The lower part first sub-magnet 29 and the lower part second sub-magnet 32 have recessed portions 35 in parts facing the first stator 4 and facing the lower part first main magnet 28 or the lower part second main magnet 31. The recessed portions 35 are respectively placed in locations corresponding to corners of the lower part first sub-magnet 29 and the lower part second sub-magnet 32.

The lower part permanent magnet 15 includes a lower part first auxiliary magnet 36 as a third magnet in the recessed portion 35 between the lower part first main magnet 28 and the lower part first sub-magnet 29. The magnetization direction 41 of the lower part first auxiliary magnet 36 is a direction intermediate between the magnetization direction 41 of the lower part first main magnet 28 and the magnetization direction 41 of the lower part first sub-magnet 29.

The lower part permanent magnet 15 includes a lower part second auxiliary magnet 37 as a third magnet in the recessed portion 35 between the lower part first sub-magnet 29 and the lower part second main magnet 31. The magnetization direction 41 of the lower part second auxiliary magnet 37 is a direction intermediate between the magnetization direction 41 of the lower part first sub-magnet 29 and the magnetization direction 41 of the lower part second main magnet 31.

The lower part permanent magnet 15 includes a lower part third auxiliary magnet 38 as a third magnet in the recessed portion 35 between the lower part second main magnet 31 and the lower part second sub-magnet 32. The magnetization direction 41 of the lower part third auxiliary magnet 38 is a direction intermediate between the magnetization direction 41 of the lower part second main magnet 31 and the magnetization direction 41 of the lower part second sub-magnet 32.

The lower part permanent magnet 15 includes a lower part fourth auxiliary magnet 39 as a third magnet in the recessed portion 35 between the lower part second sub-magnet 32 and the lower part first main magnet 28. The magnetization direction 41 of the lower part fourth auxiliary magnet 39 is a direction intermediate between the magnetization direction 41 of the lower part second sub-magnet 32 and the magnetization direction 41 of the lower part first main magnet 28.

The magnetization directions 41 of the lower part first auxiliary magnet 36, the lower part second auxiliary magnet 37, the lower part third auxiliary magnet 38, and the lower part fourth auxiliary magnet 39 are different from the lower part first direction 33, the lower part second direction 34, or the circumferential directions 7.

According to the configuration, part of lines of magnetic force 42 within the rotor 3 sequentially passes the lower part first main magnet 28, the lower part first sub-magnet 29, and the lower part second main magnet 31. The lower part first sub-magnet 29 includes the recessed portions 35 on both sides. In the recessed portions 35, the lower part first auxiliary magnet 36 and the lower part second auxiliary magnet 37 are placed. Accordingly, in the recessed portions 35, the lines of magnetic force 42 pass obliquely with respect to the lower part first direction 33, the lower part second direction 34, and the circumferential directions 7.

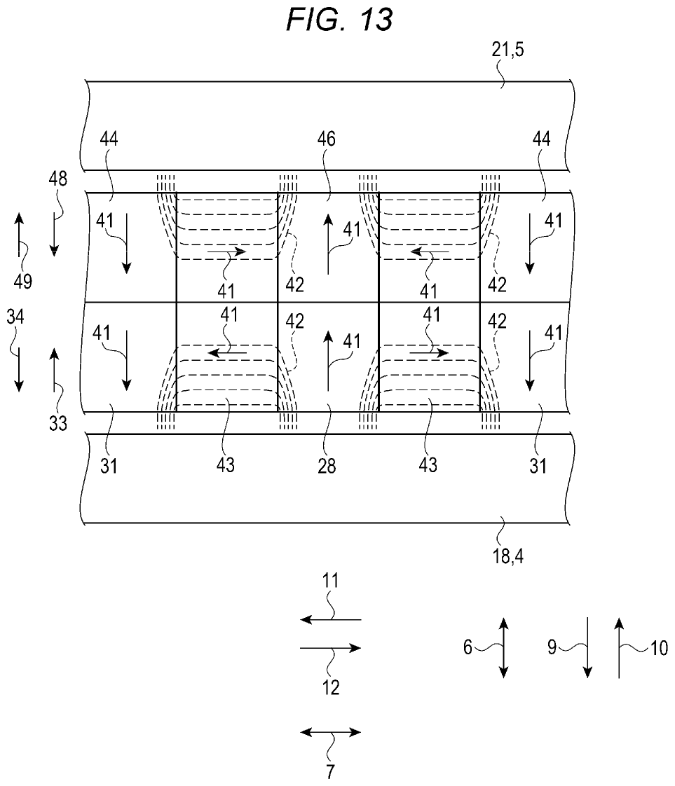

As shown in FIG. 13, without the recessed portions 35, radii of curvature of the lines of magnetic force 42 passing from the lower part first main magnet 28 to a lower part first sub-magnet 43 are smaller. Radii of curvature of the lines of magnetic force 42 passing from the lower part first sub-magnet 43 to the lower part second main magnet 31 are smaller. In this regard, a part of the lower part first sub-magnet 43 is affected by a magnetic field applied by the first stator 4 and demagnetized.

As shown in FIG. 3, in the recessed portions 35 of the embodiment, the lines of magnetic force 42 pass obliquely with respect to the lower part first direction 33, the lower part second direction 34, and the circumferential directions 7, and the radii of curvature of the lines of magnetic force 42 passing from the lower part first main magnet 28 to the lower part first sub-magnet 29 are larger. The radii of curvature of the lines of magnetic force 42 passing from the lower part first sub-magnet 29 to the lower part second main magnet 31 are larger. In this regard, demagnetization of the lower part first sub-magnet 29 may be suppressed even when the sub-magnet is affected by the magnetic field applied by the first stator 4.

The lower part second sub-magnet 32 has the same effect as the lower part first sub-magnet 29. The radii of curvature of the lines of magnetic force 42 passing from the lower part first main magnet 28 to the lower part second sub-magnet 32 are larger. The radii of curvature of the lines of magnetic force 42 passing from the lower part second sub-magnet 32 to the lower part second main magnet 31 are larger. In this regard, demagnetization of the lower part second sub-magnet 32 may be suppressed even when the sub-magnet is affected by the magnetic field applied by the first stator 4.

The upper part permanent magnet 16 has the same structure as the lower part permanent magnet 15. The upper part permanent magnet 16 of the rotor 3 has an upper part first main magnet 44 as a first main pole magnet, an upper part first sub-magnet 45 as a first sub-pole magnet, an upper part second main magnet 46 as a second main pole magnet, and an upper part second sub-magnet 47 as a second sub-pole magnet in contact with one another. The upper part first main magnet 44, the upper part first sub-magnet 45, the upper part second main magnet 46, and the upper part second sub-magnet 47 are sequentially repeatedly placed along the circumference of the rotation axis 2 for relative rotation.

The lower part first main magnet 28 and the upper part second main magnet 46 are adjoined in the axial directions 6. The lower part first main magnet 28 and the upper part second main magnet 46 have the same magnetization direction 41. The lower part first sub-magnet 29 and the upper part second sub-magnet 47 are adjoined in the axial directions 6. The lower part first sub-magnet 29 and the upper part second sub-magnet 47 have the opposite magnetization directions 41. The lower part second main magnet 31 and the upper part first main magnet 44 are adjoined in the axial directions 6. The lower part second main magnet 31 and the upper part first main magnet 44 have the same magnetization direction 41. The lower part second sub-magnet 32 and the upper part first sub-magnet 45 are adjoined in the axial directions 6. The lower part second sub-magnet 32 and the upper part first sub-magnet 45 have the opposite magnetization directions 41.

A direction from the second stator core 21 toward the rotor 3 is an upper part first direction 48 as a first direction. The magnetization direction 41 of the upper part first main magnet 44 is the upper part first direction 48. A direction from the rotor 3 toward the second stator core 21 is an upper part second direction 49 as a second direction. The magnetization direction 41 of the upper part second main magnet 46 is the upper part second direction 49. The magnetization directions 41 of the upper part first sub-magnet 45 and the upper part second sub-magnet 47 are circumferential directions 7 from the upper part first main magnet 44 toward the upper part second main magnet 46.

The upper part first sub-magnet 45 and the upper part second sub-magnet 47 have recessed portions 35 in parts facing the second stator 5 and facing the upper part first main magnet 44 or the upper part second main magnet 46. The recessed portions 35 are respectively placed in locations corresponding to corners of the upper part first sub-magnet 45 and the upper part second sub-magnet 47.

The upper part permanent magnet 16 includes an upper part first auxiliary magnet 51 as a third magnet in the recessed portion 35 between the upper part first main magnet 44 and the upper part first sub-magnet 45. The magnetization direction 41 of the upper part first auxiliary magnet 51 is a direction intermediate between the magnetization direction 41 of the upper part first main magnet 44 and the magnetization direction 41 of the upper part first sub-magnet 45.

The upper part permanent magnet 16 includes an upper part second auxiliary magnet 52 as a third magnet in the recessed portion 35 between the upper part first sub-magnet 45 and the upper part second main magnet 46. The magnetization direction 41 of the upper part second auxiliary magnet 52 is a direction intermediate between the magnetization direction 41 of the upper part first sub-magnet 45 and the magnetization direction 41 of the upper part second main magnet 46.

The upper part permanent magnet 16 includes an upper part third auxiliary magnet 53 as a third magnet in the recessed portion 35 between the upper part second main magnet 46 and the upper part second sub-magnet 47. The magnetization direction 41 of the upper part third auxiliary magnet 53 is a direction intermediate between the magnetization direction 41 of the upper part second main magnet 46 and the magnetization direction 41 of the upper part second sub-magnet 47.

The upper part permanent magnet 16 includes an upper part fourth auxiliary magnet 54 as a third magnet in the recessed portion 35 between the upper part second sub-magnet 47 and the upper part first main magnet 44. The magnetization direction 41 of the upper part fourth auxiliary magnet 54 is a direction intermediate between the magnetization direction 41 of the upper part second sub-magnet 47 and the magnetization direction 41 of the upper part first main magnet 44.

The magnetization directions 41 of the upper part first auxiliary magnet 51, the upper part second auxiliary magnet 52, the upper part third auxiliary magnet 53, and the upper part fourth auxiliary magnet 54 are different from the upper part first direction 48, the upper part second direction 49, or the circumferential directions 7.

According to the configuration, part of lines of magnetic force 42 within the rotor 3 sequentially passes the upper part first main magnet 44, the upper part first sub-magnet 45, and the upper part second main magnet 46. The upper part first sub-magnet 45 includes the recessed portions 35 on both sides. In the recessed portions 35, the upper part first auxiliary magnet 51 and the upper part second auxiliary magnet 52 are placed. Accordingly, in the recessed portions 35, the lines of magnetic force 42 pass obliquely with respect to the upper part first direction 48, the upper part second direction 49, and the circumferential directions 7.

Therefore, radii of curvature of the lines of magnetic force 42 passing from the upper part first main magnet 44 to the upper part first sub-magnet 45 are larger. Radii of curvature of the lines of magnetic force 42 passing from the upper part first sub-magnet 45 to the upper part second main magnet 46 are larger. In this regard, demagnetization of the upper part first sub-magnet 45 may be suppressed even when the sub-magnet is affected by a magnetic field applied by the second stator 5.

The upper part second sub-magnet 47 has the same effect as the upper part first sub-magnet 45. The radii of curvature of the lines of magnetic force 42 passing from the upper part first main magnet 44 to the upper part second sub-magnet 47 are larger. The radii of curvature of the lines of magnetic force 42 passing from the upper part second sub-magnet 47 to the upper part second main magnet 46 are larger. In this regard, demagnetization of the upper part second sub-magnet 47 may be suppressed even when the sub-magnet is affected by the magnetic field applied by the second stator 5. Note that the motor 1 has the double-stator structure, however, the same effects may be obtained even by a single-stator structure.

The lower part first auxiliary magnet 36 to the lower part fourth auxiliary magnet 39 and the upper part first auxiliary magnet 51 to the upper part fourth auxiliary magnet 54 are respectively magnetized in the single directions. According to the configuration, the magnetization directions 41 of the lower part first auxiliary magnet 36 to the lower part fourth auxiliary magnet 39 and the upper part first auxiliary magnet 51 to the upper part fourth auxiliary magnet 54 are the single directions, and the lower part first auxiliary magnet 36 to the lower part fourth auxiliary magnet 39 and the upper part first auxiliary magnet 51 to the upper part fourth auxiliary magnet 54 may be respectively magnetized by single magnetization. Therefore, the motor 1 may be manufactured with higher productivity.

### Second Embodiment

The embodiment is different from the first embodiment in that the shape of the recessed portion 35 is different. The same configurations as those of the first embodiment have the same signs and the overlapping explanation will be omitted.

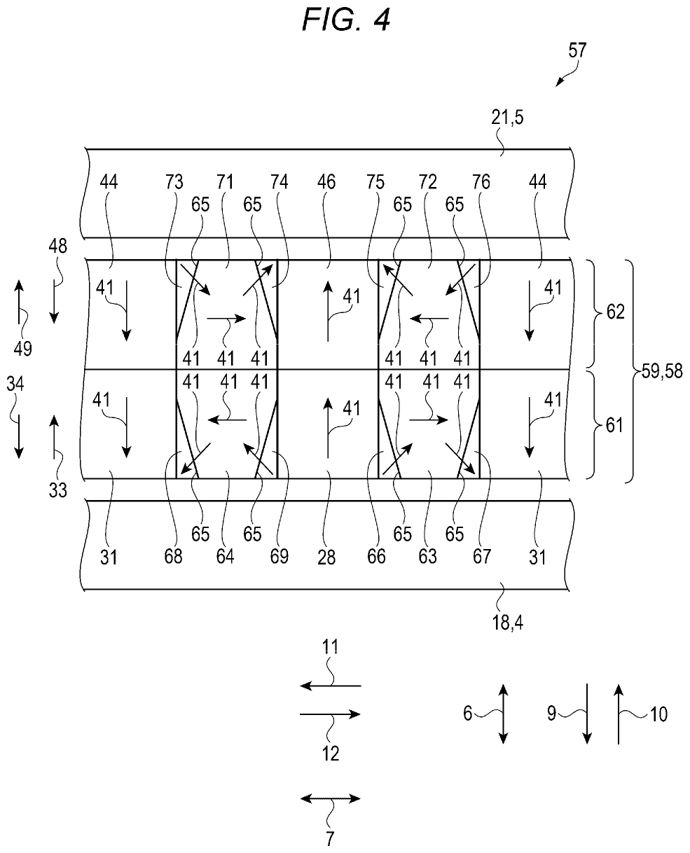

As shown in FIG. 4, a rotor 58 of a motor 57 as a rotary motor includes a permanent magnet 59. The permanent magnet 59 includes a lower part permanent magnet 61 and an upper part permanent magnet 62. The lower part permanent magnet 61 corresponds to the lower part permanent magnet 15 of the first embodiment. The upper part permanent magnet 62 corresponds to the upper part permanent magnet 16 of the first embodiment. In the lower part permanent magnet 61 of the rotor 58, the lower part first main magnet 28, a lower part first sub-magnet 63 as a first sub-pole magnet, the lower part second main magnet 31, and a lower part second sub-magnet 64 as a second sub-pole magnet are sequentially repeatedly placed along the circumference of the rotation axis 2 for relative rotation. The lower part first sub-magnet 63 corresponds to the lower part first sub-magnet 29 of the first embodiment. The lower part second sub-magnet 64 corresponds to the lower part second sub-magnet 32 of the first embodiment.

The lower part first sub-magnet 63 and the lower part second sub-magnet 64 have recessed portions 65 in parts facing the first stator 4 and facing the lower part first main magnet 28 or the lower part second main magnet 31. The recessed portions 65 are respectively placed in locations corresponding to corners of the lower part first sub-magnet 63 and the lower part second sub-magnet 64.

The lower part permanent magnet 61 includes a lower part first auxiliary magnet 66 as a third magnet in the recessed portion 65 between the lower part first main magnet 28 and the lower part first sub-magnet 63. The lower part permanent magnet 61 includes a lower part second auxiliary magnet 67 as a third magnet in the recessed portion 65 between the lower part first sub-magnet 63 and the lower part second main magnet 31. The lower part permanent magnet 61 includes a lower part third auxiliary magnet 68 as a third magnet in the recessed portion 65 between the lower part second main magnet 31 and the lower part second sub-magnet 64. The lower part permanent magnet 61 includes a lower part fourth auxiliary magnet 69 as a third magnet in the recessed portion 65 between the lower part second sub-magnet 64 and the lower part first main magnet 28.

The shapes of the lower part first auxiliary magnet 66, the lower part second auxiliary magnet 67, the lower part third auxiliary magnet 68, and the lower part fourth auxiliary magnet 69 are triangular shapes with ones of corners placed near the upper part permanent magnet 62. Therefore, radii of curvature of the lines of magnetic force 42 may be made smaller close to the upper part permanent magnet 62. The lower part first auxiliary magnet 66, the lower part second auxiliary magnet 67, the lower part third auxiliary magnet 68, and the lower part fourth auxiliary magnet 69 are apart from the upper part permanent magnet 62, and the lines of magnetic force 42 in the circumferential directions 7 pass through the lower part first sub-magnet 63 and the lower part second sub-magnet 64.

Also, in the upper part permanent magnet 62 of the rotor 58, the upper part first main magnet 44, an upper part first sub-magnet 71 as a first sub-pole magnet, the upper part second main magnet 46, and an upper part second sub-magnet 72 as a second sub-pole magnet are sequentially repeatedly placed along the circumference of the rotation axis 2 for relative rotation. The upper part first sub-magnet 71 corresponds to the upper part first sub-magnet 45 of the first embodiment. The upper part second sub-magnet 72 corresponds to the upper part second sub-magnet 47 of the first embodiment.

The upper part first sub-magnet 71 and the upper part second sub-magnet 72 have recessed portions 65 in parts facing the second stator 5 and facing the upper part first main magnet 44 or the upper part second main magnet 46. The recessed portions 65 are respectively placed in locations corresponding to corners of the upper part first sub-magnet 71 and the upper part second sub-magnet 72.

The upper part permanent magnet 62 includes an upper part first auxiliary magnet 73 as a third magnet in the recessed portion 65 between the upper part first main magnet 44 and the upper part first sub-magnet 71. The upper part permanent magnet 62 includes an upper part second auxiliary magnet 74 as a third magnet in the recessed portion 65 between the upper part first sub-magnet 71 and the upper part second main magnet 46. The upper part permanent magnet 62 includes an upper part third auxiliary magnet 75 as a third magnet in the recessed portion 65 between the upper part second main magnet 46 and the upper part second sub-magnet 72. The upper part permanent magnet 62 includes an upper part fourth auxiliary magnet 76 as a third magnet in the recessed portion 65 between the upper part second sub-magnet 72 and the upper part first main magnet 44.

The shapes of the upper part first auxiliary magnet 73, the upper part second auxiliary magnet 74, the upper part third auxiliary magnet 75, and the upper part fourth auxiliary magnet 76 are triangular shapes with ones of corners placed near the lower part permanent magnet 61. Therefore, radii of curvature of the lines of magnetic force 42 may be made smaller close to the lower part permanent magnet 61. The upper part first auxiliary magnet 73, the upper part second auxiliary magnet 74, the upper part third auxiliary magnet 75, and the upper part fourth auxiliary magnet 76 are apart from the lower part permanent magnet 61, and the lines of magnetic force 42 in the circumferential directions 7 pass through the upper part first sub-magnet 71 and the upper part second sub-magnet 72.

### Third Embodiment

The embodiment is different from the first embodiment in that putty containing a magnetic material is placed in the recessed portion 35. The same configurations as those of the first embodiment have the same signs and the overlapping explanation will be omitted.

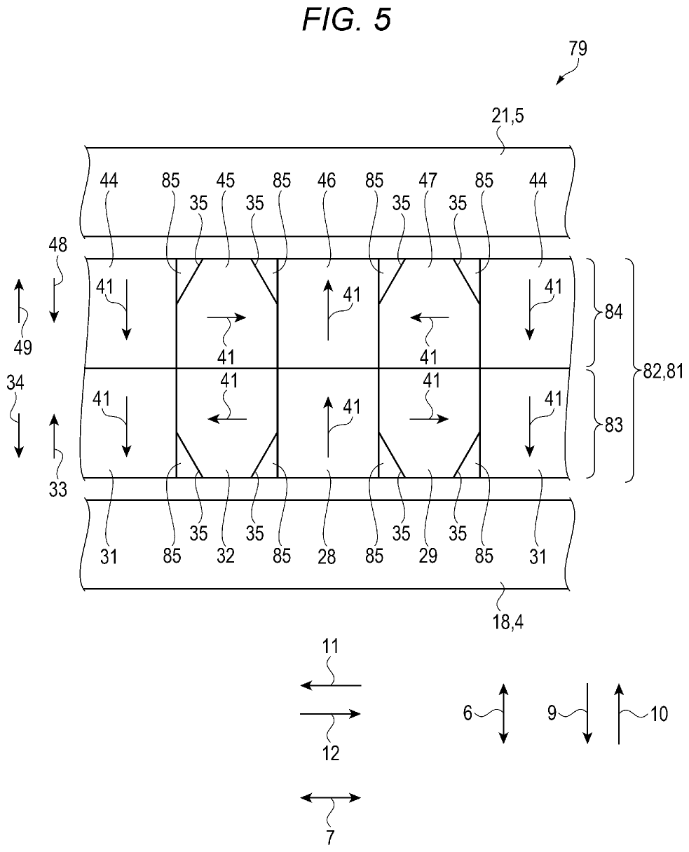

As shown in FIG. 5, a rotor 81 of a motor 79 as a rotary motor includes a permanent magnet 82. The permanent magnet 82 includes a lower part permanent magnet 83 and an upper part permanent magnet 84. The lower part permanent magnet 83 corresponds to the lower part permanent magnet 15 of the first embodiment. The upper part permanent magnet 84 corresponds to the upper part permanent magnet 16 of the first embodiment. In the lower part permanent magnet 83 of the rotor 81, the lower part first main magnet 28, the lower part first sub-magnet 29, the lower part second main magnet 31, and the lower part second sub-magnet 32 are sequentially repeatedly placed along the circumference of the rotation axis 2 for relative rotation.

The lower part first sub-magnet 29 and the lower part second sub-magnet 32 have recessed portions 35 in parts facing the first stator 4 and facing the lower part first main magnet 28 or the lower part second main magnet 31. The recessed portions 35 are respectively placed in locations corresponding to corners of the lower part first sub-magnet 29 and the lower part second sub-magnet 32. The lower part permanent magnet 83 includes fillers 85 containing a magnetic material in the recessed portions 35.

According to the configuration, the fillers 85 containing the magnetic material are placed in the recessed portions 35. Accordingly, in the recessed portions 35, the lines of magnetic force 42 pass obliquely with respect to the lower part first direction 33, the lower part second direction 34, and the circumferential directions 7.

Therefore, the radii of curvature of the lines of magnetic force 42 passing from the lower part first main magnet 28 to the lower part first sub-magnet 29 are larger. The radii of curvature of the lines of magnetic force 42 passing from the lower part first sub-magnet 29 to the lower part second main magnet 31 are larger. The radii of curvature of the lines of magnetic force 42 passing from the lower part first main magnet 28 to the lower part second sub-magnet 32 are larger. The radii of curvature of the lines of magnetic force 42 passing from the lower part second sub-magnet 32 to the lower part second main magnet 31 are larger. In this regard, demagnetization of the lower part first sub-magnet 29 may be suppressed even when the sub-magnet is affected by the magnetic field applied by the first stator 4. In this regard, demagnetization of the lower part second sub-magnet 32 may be suppressed even when the sub-magnet is affected by the magnetic field applied by the first stator 4.

In the upper part permanent magnet 84 of the rotor 81, the upper part first main magnet 44, the upper part first sub-magnet 45, the upper part second main magnet 46, and the upper part second sub-magnet 47 are sequentially repeatedly placed along the circumference of the rotation axis 2 for relative rotation.

The upper part first sub-magnet 45 and the upper part second sub-magnet 47 have recessed portions 35 in parts facing the second stator 5 and facing the upper part first main magnet 44 or the upper part second main magnet 46. The recessed portions 35 are respectively placed in locations corresponding to corners of the upper part first sub-magnet 45 and the upper part second sub-magnet 47. The upper part permanent magnet 84 includes fillers 85 containing a magnetic material in the recessed portions 35.

According to the configuration, the fillers 85 containing the magnetic material are placed in the recessed portions 35. Accordingly, in the recessed portions 35, the lines of magnetic force 42 pass obliquely with respect to the upper part first direction 48, the upper part second direction 49, and the circumferential directions 7.

Therefore, the radii of curvature of the lines of magnetic force 42 passing from the upper part first main magnet 44 to the upper part first sub-magnet 45 are larger. The radii of curvature of the lines of magnetic force 42 passing from the upper part first sub-magnet 45 to the upper part second main magnet 46 are larger. The radii of curvature of the lines of magnetic force 42 passing from the upper part first main magnet 44 to the upper part second sub-magnet 47 are larger. The radii of curvature of the lines of magnetic force 42 passing from the upper part second sub-magnet 47 to the upper part second main magnet 46 are larger. In this regard, demagnetization of the upper part first sub-magnet 45 may be suppressed even when the sub-magnet is affected by the magnetic field applied by the second stator 5. In this regard, demagnetization of the upper part second sub-magnet 47 may be suppressed even when the sub-magnet is affected by the magnetic field applied by the second stator 5.

The filler 85 containing the magnetic material is putty containing a soft magnetic material or a magnetic fluid. As the soft magnetic material, e.g. iron fine powder may be used. The putty may be formed using silicone or a resin material. The magnetic fluid may be formed by e.g. dispersion of iron fine powder in an oil or grease. According to the configuration, the putty containing the soft magnetic material and the magnetic fluid are materials easily deformable and the recessed portions 35 may be easily filled with the materials. Therefore, the motor 79 may be manufactured with higher productivity.

### Fourth Embodiment

The embodiment is different from the first embodiment in that shapes of the auxiliary magnets and the magnetization directions 41 are different. The same configurations as those of the first embodiment have the same signs and the overlapping explanation will be omitted.

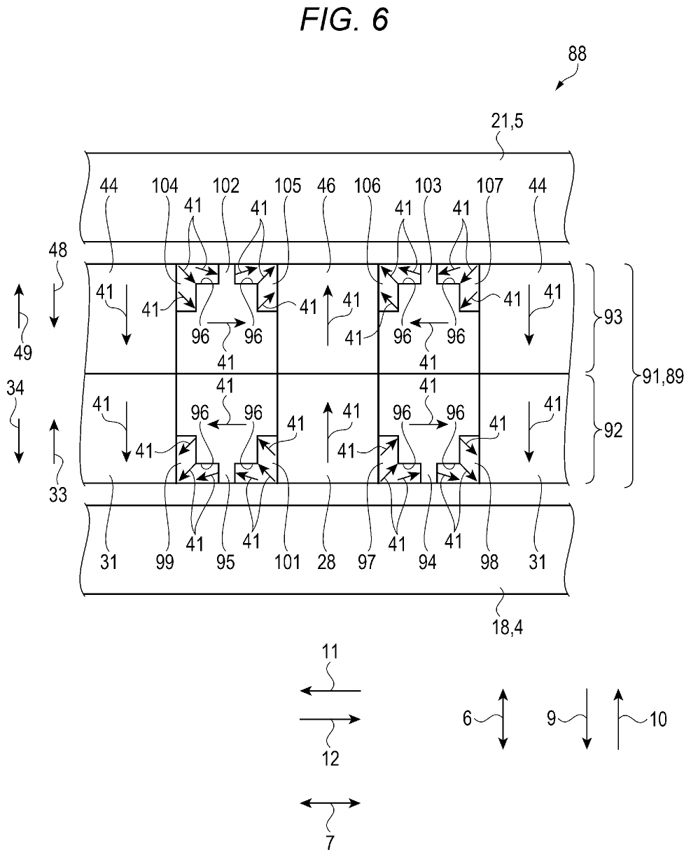

As shown in FIG. 6, a rotor 89 of a motor 88 as a rotary motor includes a permanent magnet 91. The permanent magnet 91 includes a lower part permanent magnet 92 and an upper part permanent magnet 93. The lower part permanent magnet 92 corresponds to the lower part permanent magnet 15 of the first embodiment. The upper part permanent magnet 93 corresponds to the upper part permanent magnet 16 of the first embodiment. In the lower part permanent magnet 92 of the rotor 89, the lower part first main magnet 28, a lower part first sub-magnet 94 as a first sub-pole magnet, the lower part second main magnet 31, and a lower part second sub-magnet 95 as a second sub-pole magnet are sequentially repeatedly placed along the circumference of the rotation axis 2 for relative rotation. The lower part first sub-magnet 94 corresponds to the lower part first sub-magnet 29 of the first embodiment. The lower part second sub-magnet 95 corresponds to the lower part second sub-magnet 32 of the first embodiment.

The lower part first sub-magnet 94 and the lower part second sub-magnet 95 have recessed portions 96 in parts facing the first stator 4 and facing the lower part first main magnet 28 or the lower part second main magnet 31. The recessed portions 96 are respectively placed in locations corresponding to corners of the lower part first sub-magnet 94 and the lower part second sub-magnet 95.

The lower part permanent magnet 92 includes a lower part first auxiliary magnet 97 as a third magnet in the recessed portion 96 between the lower part first main magnet 28 and the lower part first sub-magnet 94. The lower part permanent magnet 92 includes a lower part second auxiliary magnet 98 as a third magnet in the recessed portion 96 between the lower part first sub-magnet 94 and the lower part second main magnet 31. The lower part permanent magnet 92 includes a lower part third auxiliary magnet 99 as a third magnet in the recessed portion 96 between the lower part second main magnet 31 and the lower part second sub-magnet 95. The lower part permanent magnet 92 includes a lower part fourth auxiliary magnet 101 as a third magnet in the recessed portion 96 between the lower part second sub-magnet 95 and the lower part first main magnet 28.

The shapes of the lower part first auxiliary magnet 97, the lower part second auxiliary magnet 98, the lower part third auxiliary magnet 99, and the lower part fourth auxiliary magnet 101 are shapes in which rectangles elongated in the axial directions 6 and squares located in the circumferential directions 7 of the rectangles are connected. In the respective magnets, angles between the magnetization directions 41 in the parts of the rectangles elongated in the axial directions 6 and the circumferential directions 7 are about 45 degrees. In the respective magnets, angles between the magnetization directions 41 in the parts of the squares and the circumferential directions 7 are about 30 degrees.

The lower part first auxiliary magnet 97, the lower part second auxiliary magnet 98, the lower part third auxiliary magnet 99, and the lower part fourth auxiliary magnet 101 are magnetized in pluralities of directions. According to the configuration, the respective magnets of the lower part first auxiliary magnet 97, the lower part second auxiliary magnet 98, the lower part third auxiliary magnet 99, and the lower part fourth auxiliary magnet 101 are magnetized in the pluralities of directions, and radii of curvature of the lines of magnetic force 42 may be made larger. The shapes of the lines of magnetic force 42 may be made closer to shapes such that the lower part first sub-magnet 94 and the lower part second sub-magnet 95 may be harder to be demagnetized. Therefore, reduction of demagnetization of the rotor 89 may be suppressed.

Also, in the upper part permanent magnet 93 of the rotor 89, the upper part first main magnet 44, an upper part first sub-magnet 102 as a first sub-pole magnet, the upper part second main magnet 46, and an upper part second sub-magnet 103 as a second sub-pole magnet are sequentially repeatedly placed along the circumference of the rotation axis 2 for relative rotation. The upper part first sub-magnet 102 corresponds to the upper part first sub-magnet 45 of the first embodiment. The upper part second sub-magnet 103 corresponds to the upper part second sub-magnet 47 of the first embodiment.

The upper part first sub-magnet 102 and the upper part second sub-magnet 103 have recessed portions 96 in parts facing the second stator 5 and facing the upper part first main magnet 44 or the upper part second main magnet 46. The recessed portions 96 are respectively placed in locations corresponding to corners of the upper part first sub-magnet 102 and the upper part second sub-magnet 103.

The upper part permanent magnet 93 includes an upper part first auxiliary magnet 104 as a third magnet in the recessed portion 96 between the upper part first main magnet 44 and the upper part first sub-magnet 102. The upper part permanent magnet 93 includes an upper part second auxiliary magnet 105 as a third magnet in the recessed portion 96 between the upper part first sub-magnet 102 and the upper part second main magnet 46. The upper part permanent magnet 93 includes an upper part third auxiliary magnet 106 as a third magnet in the recessed portion 96 between the upper part second main magnet 46 and the upper part second sub-magnet 103. The upper part permanent magnet 93 includes an upper part fourth auxiliary magnet 107 as a third magnet in the recessed portion 96 between the upper part second sub-magnet 103 and the upper part first main magnet 44.

The shapes of the upper part first auxiliary magnet 104, the upper part second auxiliary magnet 105, the upper part third auxiliary magnet 106, and the upper part fourth auxiliary magnet 107 are shapes in which rectangles elongated in the axial directions 6 and squares located in the circumferential directions 7 of the rectangles are connected. In the respective magnets, angles between the magnetization directions 41 in the parts of the rectangles elongated in the axial directions 6 and the circumferential directions 7 are about 45 degrees. In the respective magnets, angles between the magnetization directions 41 in the parts of the squares and the circumferential directions 7 are about 30 degrees.

The upper part first auxiliary magnet 104, the upper part second auxiliary magnet 105, the upper part third auxiliary magnet 106, and the upper part fourth auxiliary magnet 107 are magnetized in pluralities of directions. According to the configuration, the respective magnets of the upper part first auxiliary magnet 104, the upper part second auxiliary magnet 105, the upper part third auxiliary magnet 106, and the upper part fourth auxiliary magnet 107 are magnetized in the pluralities of directions, and radii of curvature of the lines of magnetic force 42 may be made larger. The shapes of the lines of magnetic force 42 may be made closer to shapes such that the upper part first sub-magnet 102 and the upper part second sub-magnet 103 may be harder to be demagnetized. Therefore, reduction of demagnetization of the rotor 89 may be suppressed.

### Fifth Embodiment

The embodiment is different from the fourth embodiment in that each auxiliary magnet is formed from a plurality of magnets. The same configurations as those of the fourth embodiment have the same signs and the overlapping explanation will be omitted.

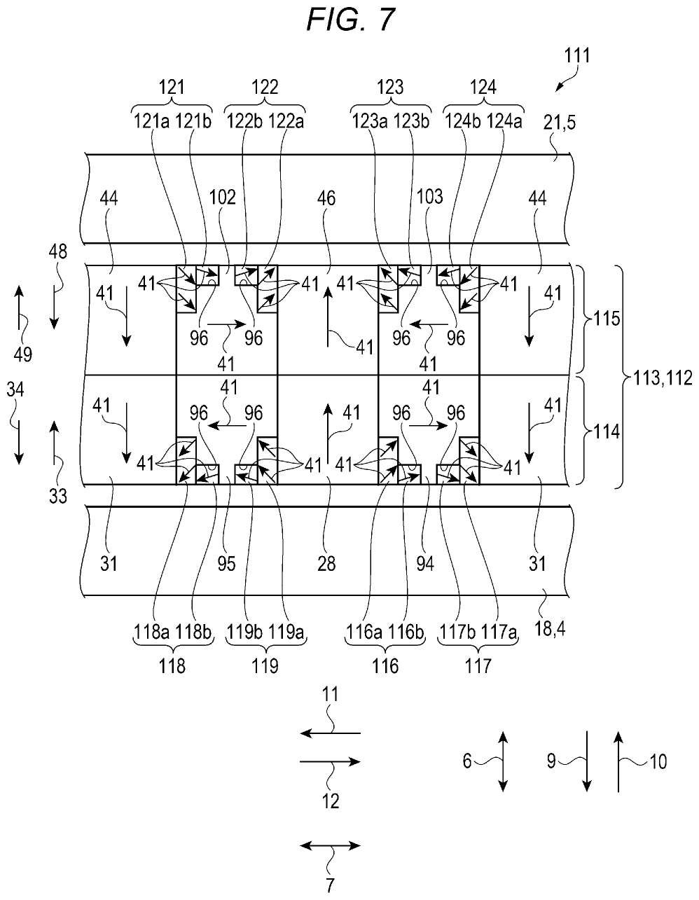

As shown in FIG. 7, a rotor 112 of a motor 111 as a rotary motor includes a permanent magnet 113. The permanent magnet 113 includes a lower part permanent magnet 114 and an upper part permanent magnet 115. The lower part permanent magnet 114 corresponds to the lower part permanent magnet 92 of the fourth embodiment. The upper part permanent magnet 115 corresponds to the upper part permanent magnet 93 of the fourth embodiment. In the lower part permanent magnet 114 of the rotor 112, the lower part first main magnet 28, the lower part first sub-magnet 94, the lower part second main magnet 31, and the lower part second sub-magnet 95 are sequentially repeatedly placed along the circumference of the rotation axis 2 for relative rotation.

The lower part permanent magnet 114 includes a lower part first auxiliary magnet 116 as a third magnet in the recessed portion 96 between the lower part first main magnet 28 and the lower part first sub-magnet 94. The lower part first auxiliary magnet 116 includes a first small magnet 116a and a second small magnet 116b. The shape of the first small magnet 116a is a rectangle elongated in the axial directions 6. The shape of the second small magnet 116b is a square along the circumferential directions 7. An angle between the magnetization direction 41 of the first small magnet 116a and the circumferential directions 7 is about 45 degrees. An angle between the magnetization direction 41 of the second small magnet 116b and the circumferential directions 7 is about 30 degrees.

The lower part permanent magnet 114 includes a lower part second auxiliary magnet 117 as a third magnet in the recessed portion 96 between the lower part first sub-magnet 94 and the lower part second main magnet 31. The lower part second auxiliary magnet 117 includes a third small magnet 117a and a fourth small magnet 117b. The shape of the third small magnet 117a is a rectangle elongated in the axial directions 6. The shape of the fourth small magnet 117b is a square along the circumferential directions 7. An angle between the magnetization direction 41 of the third small magnet 117a and the circumferential directions 7 is about 45 degrees. An angle between the magnetization direction 41 of the fourth small magnet 117b and the circumferential directions 7 is about 30 degrees.

The lower part permanent magnet 114 includes a lower part third auxiliary magnet 118 as a third magnet in the recessed portion 96 between the lower part second main magnet 31 and the lower part second sub-magnet 95. The lower part third auxiliary magnet 118 includes a fifth small magnet 118a and a sixth small magnet 118b. The shape of the fifth small magnet 118a is a rectangle elongated in the axial directions 6. The shape of the sixth small magnet 118b is a square along the circumferential directions 7. An angle between the magnetization direction 41 of the fifth small magnet 118a and the circumferential directions 7 is about 45 degrees. An angle between the magnetization direction 41 of the sixth small magnet 118b and the circumferential directions 7 is about 30 degrees.

The lower part permanent magnet 114 includes a lower part fourth auxiliary magnet 119 as a third magnet in the recessed portion 96 between the lower part second sub-magnet 95 and the lower part first main magnet 28. The lower part fourth auxiliary magnet 119 includes a seventh small magnet 119a and an eighth small magnet 119b. The shape of the seventh small magnet 119a is a rectangle elongated in the axial directions 6. The shape of the eighth small magnet 119b is a square along the circumferential directions 7. An angle between the magnetization direction 41 of the seventh small magnet 119a and the circumferential directions 7 is about 45 degrees. An angle between the magnetization direction 41 of the eighth small magnet 119b and the circumferential directions 7 is about 30 degrees.

The lower part first auxiliary magnet 116, the lower part second auxiliary magnet 117, the lower part third auxiliary magnet 118, and the lower part fourth auxiliary magnet 119 are respectively formed using pluralities of magnets magnetized in different directions. According to the configuration, the lower part first auxiliary magnet 116, the lower part second auxiliary magnet 117, the lower part third auxiliary magnet 118, and the lower part fourth auxiliary magnet 119 respectively include the pluralities of magnets magnetized in the different directions. Accordingly, the respective auxiliary magnets have pluralities of magnetization directions, and the radii of curvature of the lines of magnetic force 42 may be made larger. The shapes of the lines of magnetic force 42 may be made closer to shapes such that the sub-pole magnets may be harder to be demagnetized. Therefore, reduction of demagnetization of the rotor 112 may be suppressed.

The first small magnet 116a to the eighth small magnet 119b are respectively magnetized in the single directions. Therefore, the small magnets may be manufactured more easily than in a case where a single small magnet is magnetized in a plurality of directions.

In the upper part permanent magnet 115 of the rotor 112, the upper part first main magnet 44, the upper part first sub-magnet 102, the upper part second main magnet 46, and the upper part second sub-magnet 103 are sequentially repeatedly placed along the circumference of the rotation axis 2 for relative rotation.

The upper part permanent magnet 115 includes an upper part first auxiliary magnet 121 as a third magnet in the recessed portion 96 between the upper part first main magnet 44 and the upper part first sub-magnet 102. The upper part first auxiliary magnet 121 includes a ninth small magnet 121a and a 10th small magnet 121b. The shape of the ninth small magnet 121a is a rectangle elongated in the axial directions 6. The shape of the 10th small magnet 121b is a square along the circumferential directions 7. An angle between the magnetization direction 41 of the ninth small magnet 121a and the circumferential directions 7 is about 45 degrees. An angle between the magnetization direction 41 of the 10th small magnet 121b and the circumferential directions 7 is about 30 degrees.

The upper part permanent magnet 115 includes an upper part second auxiliary magnet 122 as a third magnet in the recessed portion 96 between the upper part first sub-magnet 102 and the upper part second main magnet 46. The upper part second auxiliary magnet 122 includes an 11th small magnet 122a and a 12th small magnet 122b. The shape of the 11th small magnet 122a is a rectangle elongated in the axial directions 6. The shape of the 12th small magnet 122b is a square along the circumferential directions 7. An angle between the magnetization direction 41 of the 11th small magnet 122a and the circumferential directions 7 is about 45 degrees. An angle between the magnetization direction 41 of the 12th small magnet 122b and the circumferential directions 7 is about 30 degrees.

The upper part permanent magnet 115 includes an upper part third auxiliary magnet 123 as a third magnet in the recessed portion 96 between the upper part second main magnet 46 and the upper part second sub-magnet 103. The upper part third auxiliary magnet 123 includes a 13th small magnet 123a and a 14th small magnet 123b. The shape of the 13th small magnet 123a is a rectangle elongated in the axial directions 6. The shape of the 14th small magnet 123b is a square along the circumferential directions 7. An angle between the magnetization direction 41 of the 13th small magnet 123a and the circumferential directions 7 is about 45 degrees. An angle between the magnetization direction 41 of the 14th small magnet 123b and the circumferential directions 7 is about 30 degrees.

The upper part permanent magnet 115 includes an upper part fourth auxiliary magnet 124 as a third magnet in the recessed portion 96 between the upper part second sub-magnet 103 and the upper part first main magnet 44. The upper part fourth auxiliary magnet 124 includes a 15th small magnet 124a and a 16th small magnet 124b. The shape of the 15th small magnet 124a is a rectangle elongated in the axial directions 6. The shape of the 16th small magnet 124b is a square along the circumferential directions 7. An angle between the magnetization direction 41 of the 15th small magnet 124a and the circumferential directions 7 is about 45 degrees. An angle between the magnetization direction 41 of the 16th small magnet 124b and the circumferential directions 7 is about 30 degrees.

The upper part first auxiliary magnet 121, the upper part second auxiliary magnet 122, the upper part third auxiliary magnet 123, and the upper part fourth auxiliary magnet 124 are respectively formed using pluralities of magnets magnetized in different directions. According to the configuration, the upper part first auxiliary magnet 121, the upper part second auxiliary magnet 122, the upper part third auxiliary magnet 123, and the upper part fourth auxiliary magnet 124 respectively include the pluralities of magnets magnetized in the different directions. Accordingly, the respective auxiliary magnets have pluralities of magnetization directions, and the radii of curvature of the lines of magnetic force 42 may be made larger. The shapes of the lines of magnetic force 42 may be made closer to shapes such that the sub-pole magnets may be harder to be demagnetized. Therefore, reduction of demagnetization of the rotor 112 may be suppressed.

The ninth small magnet 121a to the 16th small magnet 124b are respectively magnetized in the single directions. Therefore, the small magnets may be manufactured more easily than in a case where a single small magnet is magnetized in a plurality of directions.

### Sixth Embodiment

The embodiment is different from the first embodiment in that shapes of the auxiliary magnets and the magnetization directions 41 are different. The same configurations as those of the first embodiment have the same signs and the overlapping explanation will be omitted.

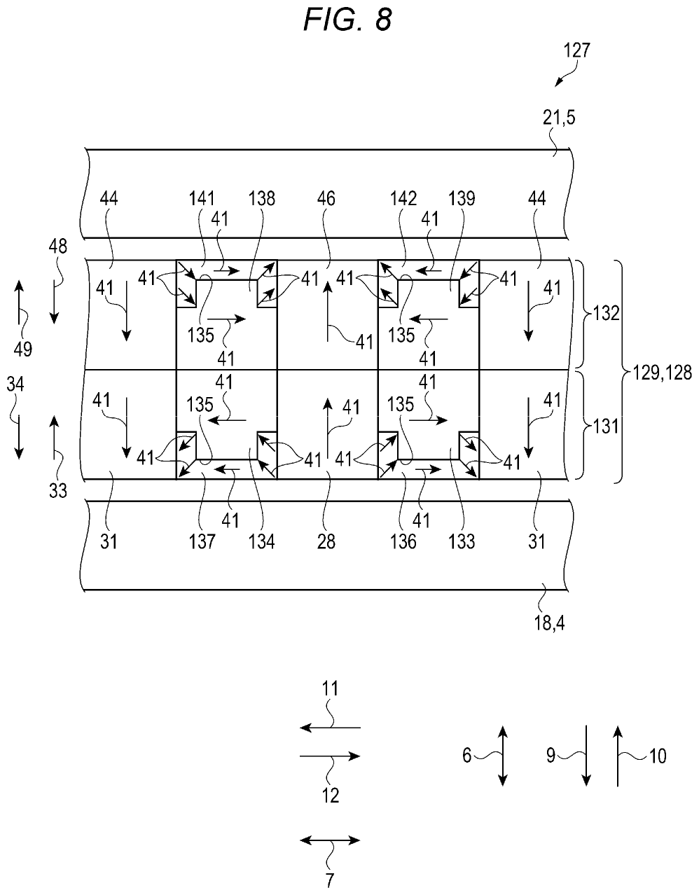

As shown in FIG. 8, a rotor 128 of a motor 127 as a rotary motor includes a permanent magnet 129. The permanent magnet 129 includes a lower part permanent magnet 131 and an upper part permanent magnet 132. The lower part permanent magnet 131 corresponds to the lower part permanent magnet 15 of the first embodiment. The upper part permanent magnet 132 corresponds to the upper part permanent magnet 16 of the first embodiment. In the lower part permanent magnet 131 of the rotor 128, the lower part first main magnet 28, a lower part first sub-magnet 133 as a first sub-pole magnet, the lower part second main magnet 31, and a lower part second sub-magnet 134 as a second sub-pole magnet are sequentially repeatedly placed along the circumference of the rotation axis 2 for relative rotation. The lower part first sub-magnet 133 corresponds to the lower part first sub-magnet 29 of the first embodiment. The lower part second sub-magnet 134 corresponds to the lower part second sub-magnet 32 of the first embodiment.

The lower part first sub-magnet 133 and the lower part second sub-magnet 134 have recessed portions 135 in parts facing the first stator 4 and facing the lower part first main magnet 28 or the lower part second main magnet 31. Further, the recessed portions 135 are respectively placed between corners of the lower part first sub-magnet 133 and the lower part second sub-magnet 134 facing the first stator 4.

The lower part permanent magnet 131 includes a lower part first auxiliary magnet 136 as a third magnet in the recessed portion 135 of the lower part first sub-magnet 133. The lower part permanent magnet 131 includes a lower part second auxiliary magnet 137 as a third magnet in the recessed portion 135 of the lower part second sub-magnet 134.

The shapes of the lower part first auxiliary magnet 136 and the lower part second auxiliary magnet 137 are shapes in which rectangles elongated in the axial directions 6 and rectangles elongated in the circumferential directions 7 are connected along the lower part first main magnet 28 or the lower part second main magnet 31. In the respective magnets, angles between the magnetization directions 41 in the parts of the rectangles elongated in the axial directions 6 and the circumferential directions 7 are about 45 degrees. Angles between the magnetization directions 41 in the parts of the rectangles elongated in the circumferential directions 7 and the circumferential directions 7 are about 0 degrees.

The lower part first auxiliary magnet 136 and the lower part second auxiliary magnet 137 are magnetized in pluralities of directions. According to the configuration, the respective magnets of the lower part first auxiliary magnet 136 and the lower part second auxiliary magnet 137 are magnetized in the pluralities of directions, and radii of curvature of the lines of magnetic force 42 may be made larger. The shapes of the lines of magnetic force 42 may be made closer to shapes such that the lower part first sub-magnet 133 and the lower part second sub-magnet 134 may be harder to be demagnetized. Therefore, reduction of demagnetization of the rotor 128 may be suppressed.

Also, in the upper part permanent magnet 132 of the rotor 128, the upper part first main magnet 44, an upper part first sub-magnet 138 as a first sub-pole magnet, the upper part second main magnet 46, and an upper part second sub-magnet 139 as a second sub-pole magnet are sequentially repeatedly placed along the circumference of the rotation axis 2 for relative rotation. The upper part first sub-magnet 138 corresponds to the upper part first sub-magnet 45 of the first embodiment. The upper part second sub-magnet 139 corresponds to the upper part second sub-magnet 47 of the first embodiment.

The upper part first sub-magnet 138 and the upper part second sub-magnet 139 have recessed portions 135 in parts facing the second stator 5 and facing the upper part first main magnet 44 or the upper part second main magnet 46. The recessed portions 135 are also respectively formed between corners of the upper part first sub-magnet 138 and the upper part second sub-magnet 139 facing the second stator 5.

The upper part permanent magnet 132 includes an upper part first auxiliary magnet 141 as a third magnet in the recessed portion 135 of the upper part first sub-magnet 138. The upper part permanent magnet 132 includes an upper part second auxiliary magnet 142 as a third magnet in the recessed portion 135 of the upper part second sub-magnet 139.

The shapes of the upper part first auxiliary magnet 141 and the upper part second auxiliary magnet 142 are shapes in which rectangles elongated in the axial directions 6 and rectangles elongated in the circumferential directions 7 are connected along the upper part first main magnet 44 or the upper part second main magnet 46. In the respective magnets, angles between the magnetization directions 41 in the parts of the rectangles elongated in the axial directions 6 and the circumferential directions 7 are about 45 degrees. In the respective magnets, angles between the magnetization directions 41 in the parts of the rectangles elongated in the circumferential directions 7 and the circumferential directions 7 are about 0 degrees.

The upper part first auxiliary magnet 141 and the upper part second auxiliary magnet 142 are magnetized in pluralities of directions. According to the configuration, the respective magnets of the upper part first auxiliary magnet 141 and the upper part second auxiliary magnet 142 are magnetized in the pluralities of directions, and radii of curvature of the lines of magnetic force 42 may be made larger. The shapes of the lines of magnetic force 42 may be made closer to shapes such that the upper part first sub-magnet 138 and the upper part second sub-magnet 139 may be harder to be demagnetized. Therefore, reduction of demagnetization of the rotor 128 may be suppressed.

### Seventh Embodiment

The embodiment is different from the sixth embodiment in that each auxiliary magnet is formed from a plurality of magnets. The same configurations as those of the sixth embodiment have the same signs and the overlapping explanation will be omitted.

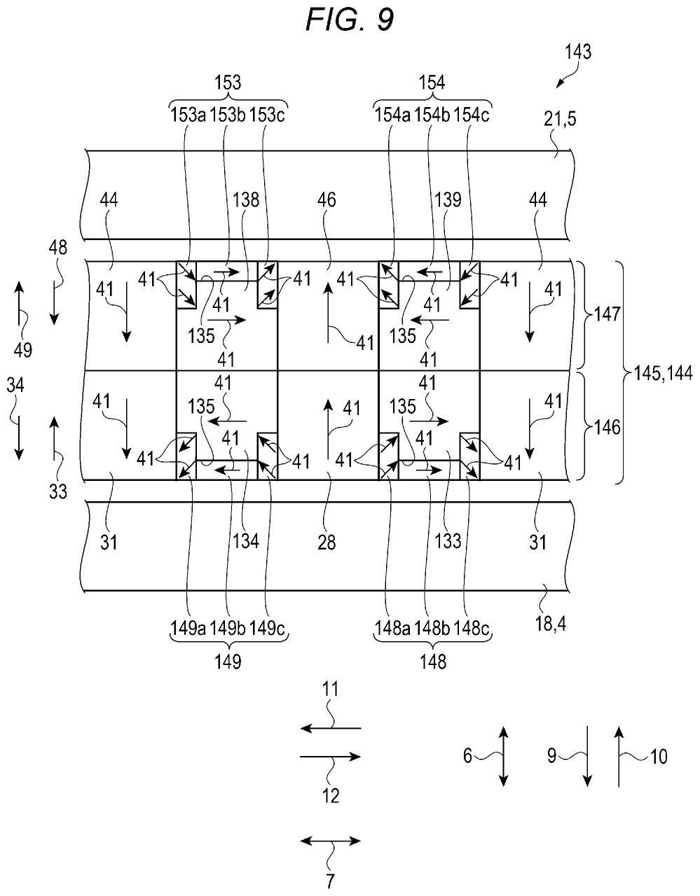

As shown in FIG. 9, a rotor 144 of a motor 143 as a rotary motor includes a permanent magnet 145. The permanent magnet 145 includes a lower part permanent magnet 146 and an upper part permanent magnet 147. The lower part permanent magnet 146 corresponds to the lower part permanent magnet 131 of the sixth embodiment. The upper part permanent magnet 147 corresponds to the upper part permanent magnet 132 of the sixth embodiment. In the lower part permanent magnet 146 of the rotor 144, the lower part first main magnet 28, the lower part first sub-magnet 133, the lower part second main magnet 31, and the lower part second sub-magnet 134 are sequentially repeatedly placed along the circumference of the rotation axis 2 for relative rotation.

The lower part permanent magnet 146 includes a lower part first auxiliary magnet 148 as a third magnet in the recessed portion 135 of the lower part first sub-magnet 133. The lower part first auxiliary magnet 148 includes a first small magnet 148a, a second small magnet 148b, and a third small magnet 148c. The shape of the first small magnet 148a is a rectangle elongated in the axial directions 6 along the lower part first main magnet 28. The shape of the second small magnet 148b is a rectangle along the circumferential directions 7. The shape of the third small magnet 148c is a rectangle elongated in the axial directions 6 along the lower part second main magnet 31. Angles between the magnetization directions 41 of the first small magnet 148a and the third small magnet 148c and the circumferential directions 7 are about 45 degrees. An angle between the magnetization direction 41 of the second small magnet 148b and the circumferential directions 7 is about 0 degrees.

The lower part permanent magnet 146 includes a lower part second auxiliary magnet 149 as a third magnet in the recessed portion 135 of the lower part second sub-magnet 134. The lower part second auxiliary magnet 149 includes a fourth small magnet 149a, a fifth small magnet 149b, and a sixth small magnet 149c. The shape of the fourth small magnet 149a is a rectangle elongated in the axial directions 6 along the lower part second main magnet 31. The shape of the fifth small magnet 149b is a rectangle along the circumferential directions 7. The shape of the sixth small magnet 149c is a rectangle elongated in the axial directions 6 along the lower part first main magnet 28. Angles between the magnetization directions 41 of the fourth small magnet 149a and the sixth small magnet 149c and the circumferential directions 7 are about 45 degrees. An angle between the magnetization direction 41 of the fifth small magnet 149b and the circumferential directions 7 is about 0 degrees.

The lower part first auxiliary magnet 148 and the lower part second auxiliary magnet 149 are respectively formed using pluralities of magnets magnetized in different directions. According to the configuration, the lower part first auxiliary magnet 148 and the lower part second auxiliary magnet 149 respectively include the pluralities of magnets magnetized in the different directions. Accordingly, there are pluralities of magnetization directions of the respective auxiliary magnets, and the radii of curvature of the lines of magnetic force 42 may be made larger. The shapes of the lines of magnetic force 42 may be made closer to shapes such that the sub-pole magnets may be harder to be demagnetized. Therefore, reduction of demagnetization of the rotor 144 may be suppressed.

In the upper part permanent magnet 147 of the rotor 144, the upper part first main magnet 44, the upper part first sub-magnet 138, the upper part second main magnet 46, and the upper part second sub-magnet 139 are sequentially repeatedly placed along the circumference of the rotation axis 2 for relative rotation.

The upper part permanent magnet 147 includes an upper part first auxiliary magnet 153 as a third magnet in the recessed portion 135 of the upper part first sub-magnet 138. The upper part first auxiliary magnet 153 includes a seventh small magnet 153a, an eighth small magnet 153b, and a ninth small magnet 153c. The shape of the seventh small magnet 153a is a rectangle elongated in the axial directions 6 along the upper part first main magnet 44. The shape of the eighth small magnet 153b is a rectangle along the circumferential directions 7. The shape of the ninth small magnet 153c is a rectangle elongated in the axial directions 6 along the upper part second main magnet 46. Angles between the magnetization directions 41 of the seventh small magnet 153a and the ninth small magnet 153c and the circumferential directions 7 are about 45 degrees. An angle between the magnetization direction 41 of the eighth small magnet 153b and the circumferential directions 7 is about 0 degrees.

The upper part permanent magnet 147 includes an upper part second auxiliary magnet 154 as a third magnet in the recessed portion 135 of the upper part second sub-magnet 139. The upper part second auxiliary magnet 154 includes a 10th small magnet 154a, an 11th small magnet 154b, and a 12th small magnet 154c. The shape of the 10th small magnet 154a is a rectangle elongated in the axial directions 6 along the upper part second main magnet 46. The shape of the 11th small magnet 154b is a rectangle along the circumferential directions 7. The shape of the 12th small magnet 154c is a rectangle elongated in the axial directions 6 along the upper part first main magnet 44. Angles between the magnetization directions 41 of the 10th small magnet 154a and the 12th small magnet 154c and the circumferential directions 7 are about 45 degrees. An angle between the magnetization direction 41 of the 11th small magnet 154b and the circumferential directions 7 is about 0 degrees.

The upper part first auxiliary magnet 153 and the upper part second auxiliary magnet 154 are respectively formed using pluralities of magnets magnetized in different directions. According to the configuration, the upper part first auxiliary magnet 153 and the upper part second auxiliary magnet 154 respectively include the pluralities of magnets magnetized in the different directions. Accordingly, there are pluralities of magnetization directions of the respective auxiliary magnets, and the radii of curvature of the lines of magnetic force 42 may be made larger. The shapes of the lines of magnetic force 42 may be made closer to shapes such that the sub-pole magnets may be harder to be demagnetized. Therefore, reduction of demagnetization of the rotor 144 may be suppressed.

The first small magnet 148a to the 12th small magnet 154c are respectively magnetized in the single directions. Therefore, the small magnets may be manufactured more easily than in a case where a single small magnet is magnetized in a plurality of directions.

### Eighth Embodiment

The embodiment is different from the third embodiment in that the recessed portion includes a curved surface. The same configurations as those of the third embodiment have the same signs and the overlapping explanation will be omitted.

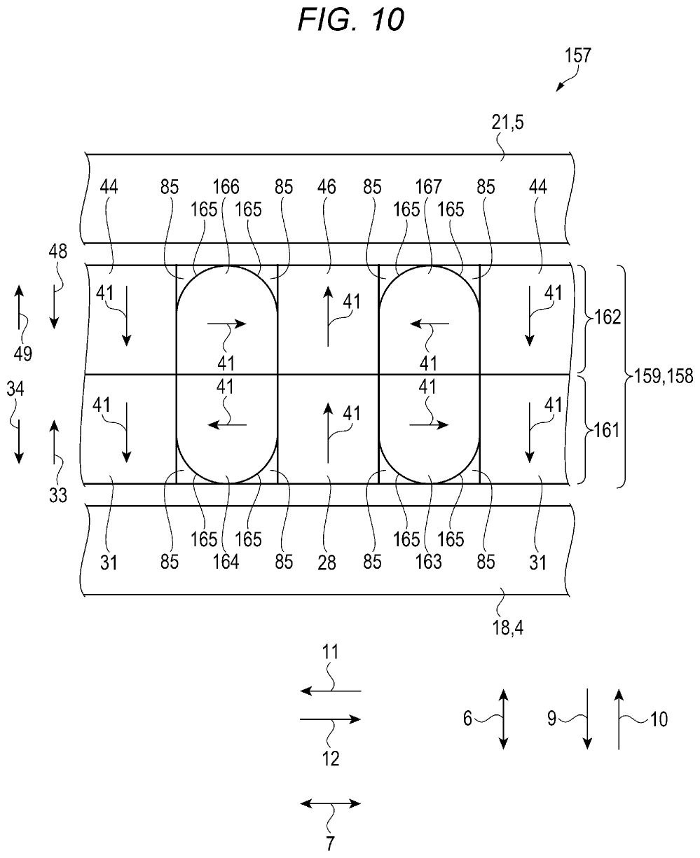

As shown in FIG. 10, a rotor 158 of a motor 157 as a rotary motor includes a permanent magnet 159. The permanent magnet 159 includes a lower part permanent magnet 161 and an upper part permanent magnet 162. The lower part permanent magnet 161 corresponds to the lower part permanent magnet 83 of the third embodiment. The upper part permanent magnet 162 corresponds to the upper part permanent magnet 84 of the third embodiment. In the lower part permanent magnet 161 of the rotor 158, the lower part first main magnet 28, a lower part first sub-magnet 163 as a first sub-pole magnet, the lower part second main magnet 31, and a lower part second sub-magnet 164 as a second sub-pole magnet are sequentially repeatedly placed along the circumference of the rotation axis 2 for relative rotation.

The lower part first sub-magnet 163 and the lower part second sub-magnet 164 have recessed portions 165 in parts facing the first stator 4 and facing the lower part first main magnet 28 or the lower part second main magnet 31. The recessed portions 165 are respectively placed in locations corresponding to corners of the lower part first sub-magnet 163 and the lower part second sub-magnet 164. The lower part permanent magnet 161 includes fillers 85 containing a magnetic material in the recessed portions 165. The recessed portion 165 of the lower part first sub-magnet 163 has an arc-shaped surface facing the center of gravity of the lower part first sub-magnet 163. The recessed portion 165 of the lower part second sub-magnet 164 has an arc-shaped surface facing the center of gravity of the lower part second sub-magnet 164.

According to the configuration, the fillers 85 containing the magnetic material are placed in the recessed portions 165. Accordingly, in the recessed portions 165, the lines of magnetic force 42 pass obliquely with respect to the lower part first direction 33, the lower part second direction 34, and the circumferential directions 7.

Therefore, the radii of curvature of the lines of magnetic force 42 passing from the lower part first main magnet 28 to the lower part first sub-magnet 163 are larger. The radii of curvature of the lines of magnetic force 42 passing from the lower part first sub-magnet 163 to the lower part second main magnet 31 are larger. The radii of curvature of the lines of magnetic force 42 passing from the lower part first main magnet 28 to the lower part second sub-magnet 164 are larger. The radii of curvature of the lines of magnetic force 42 passing from the lower part second sub-magnet 164 to the lower part second main magnet 31 are larger. In this regard, demagnetization of the lower part first sub-magnet 163 and the lower part second sub-magnet 164 may be suppressed even when the sub-magnets are affected by the magnetic field applied by the first stator 4.

In the upper part permanent magnet 162 of the rotor 158, the upper part first main magnet 44, an upper part first sub-magnet 166 as a first sub-pole magnet, the upper part second main magnet 46, and an upper part second sub-magnet 167 as a second sub-pole magnet are sequentially repeatedly placed along the circumference of the rotation axis 2 for relative rotation.

The upper part first sub-magnet 166 and the upper part second sub-magnet 167 have recessed portions 165 in parts facing the second stator 5 and facing the upper part first main magnet 44 or the upper part second main magnet 46. The recessed portions 165 are respectively placed in locations corresponding to corners of the upper part first sub-magnet 166 and the upper part second sub-magnet 167. The upper part permanent magnet 162 includes fillers 85 containing a magnetic material in the recessed portions 165. The recessed portion 165 of the upper part first sub-magnet 166 has an arc-shaped surface facing the center of gravity of the upper part first sub-magnet 166. The recessed portion 165 of the upper part second sub-magnet 167 has an arc-shaped surface facing the center of gravity of the upper part second sub-magnet 167.

According to the configuration, the fillers 85 containing the magnetic material are placed in the recessed portions 165. Accordingly, in the recessed portions 165, the lines of magnetic force 42 pass obliquely with respect to the upper part first direction 48, the upper part second direction 49, and the circumferential directions 7.

Therefore, the radii of curvature of the lines of magnetic force 42 passing from the upper part first main magnet 44 to the upper part first sub-magnet 166 are larger. The radii of curvature of the lines of magnetic force 42 passing from the upper part first sub-magnet 166 to the upper part second main magnet 46 are larger. The radii of curvature of the lines of magnetic force 42 passing from the upper part first main magnet 44 to the upper part second sub-magnet 167 are larger. The radii of curvature of the lines of magnetic force 42 passing from the upper part second sub-magnet 167 to the upper part second main magnet 46 are larger. In this regard, demagnetization of the upper part first sub-magnet 166 may be suppressed even when the sub-magnet is affected by the magnetic field applied by the second stator 5. In this regard, demagnetization of the upper part second sub-magnet 167 may be suppressed even when the sub-magnet is affected by the magnetic field applied by the second stator 5.

### Ninth Embodiment

The embodiment is different from the first embodiment in that the motor is a radial gap motor. The same configurations as those of the first embodiment have the same signs and the overlapping explanation will be omitted.

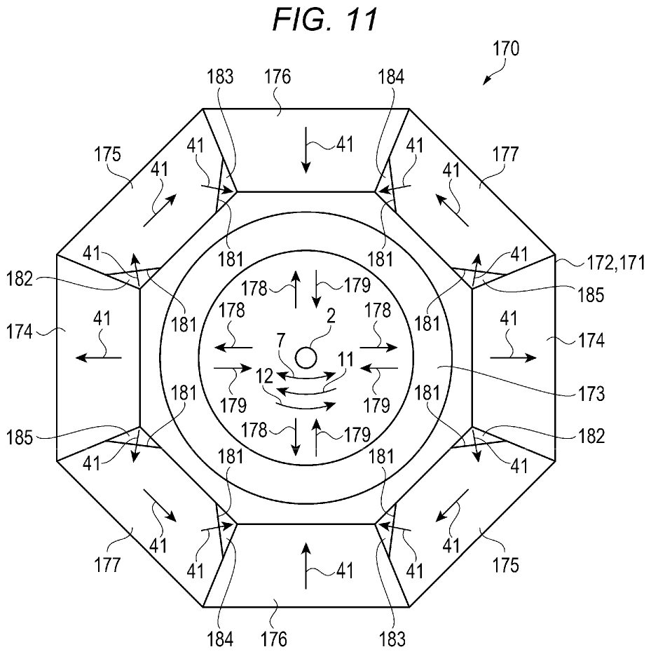

As shown in FIG. 11, a motor 170 as a rotary motor includes a rotor 171 having an annular shape rotating around the rotation axis 2 and a stator 173 placed at the rotation axis 2 side of the rotor 171. The rotor 171 rotates relative to the stator 173. The motor 170 rotates the rotor 171 around the rotation axis 2.

The rotor 171 includes a permanent magnet 172. The permanent magnet 172 of the rotor 171 has a first main pole magnet 174, a first sub-pole magnet 175, a second main pole magnet 176, and a second sub-pole magnet 177 in contact with one another. The first main pole magnet 174, the first sub-pole magnet 175, the second main pole magnet 176, and the second sub-pole magnet 177 are sequentially repeatedly placed along the circumference of the rotation axis 2 for relative rotation.

A direction from the stator 173 toward the rotor 171 is a first radial direction 178 as a first direction. The magnetization direction 41 of the first main pole magnet 174 is the first radial direction 178. A direction from the rotor 171 toward the stator 173 is a second radial direction 179 as a second direction. The magnetization direction 41 of the second main pole magnet 176 is the second radial direction 179. The magnetization directions 41 of the first sub-pole magnet 175 and the second sub-pole magnet 177 are circumferential directions 7 from the first main pole magnet 174 toward the second main pole magnet 176.

The first sub-pole magnet 175 and the second sub-pole magnet 177 have recessed portions 181 in parts facing the stator 173 and facing the first main pole magnet 174 or the second main pole magnet 176. The recessed portions 181 are respectively placed in locations corresponding to corners of the first sub-pole magnet 175 and the second sub-pole magnet 177.

The permanent magnet 172 includes a first auxiliary magnet 182 as a third magnet in the recessed portion 181 between the first main pole magnet 174 and the first sub-pole magnet 175. The magnetization direction 41 of the first auxiliary magnet 182 is a direction intermediate between the magnetization direction 41 of the first main pole magnet 174 and the magnetization direction 41 of the first sub-pole magnet 175.

The permanent magnet 172 includes a second auxiliary magnet 183 as a third magnet in the recessed portion 181 between the first sub-pole magnet 175 and the second main pole magnet 176. The magnetization direction 41 of the second auxiliary magnet 183 is a direction intermediate between the magnetization direction 41 of the first sub-pole magnet 175 and the magnetization direction 41 of the second main pole magnet 176.

The permanent magnet 172 includes a third auxiliary magnet 184 as a third magnet in the recessed portion 181 between the second main pole magnet 176 and the second sub-pole magnet 177. The magnetization direction 41 of the third auxiliary magnet 184 is a direction intermediate between the magnetization direction 41 of the second main pole magnet 176 and the magnetization direction 41 of the second sub-pole magnet 177.

The permanent magnet 172 includes a fourth auxiliary magnet 185 as a third magnet in the recessed portion 181 between the second sub-pole magnet 177 and the first main pole magnet 174. The magnetization direction 41 of the fourth auxiliary magnet 185 is a direction intermediate between the magnetization direction 41 of the second sub-pole magnet 177 and the magnetization direction 41 of the first main pole magnet 174.

The magnetization directions 41 of the first auxiliary magnet 182, the second auxiliary magnet 183, the third auxiliary magnet 184, and the fourth auxiliary magnet 185 are different from the first radial direction 178, the second radial direction 179, or the circumferential directions 7.

According to the configuration, part of the lines of magnetic force 42 within the rotor 171 sequentially passes the first main pole magnet 174, the first sub-pole magnet 175, and the second main pole magnet 176. The first sub-pole magnet 175 includes the recessed portions 181 on both sides. In the recessed portions 181, the first auxiliary magnet 182 and the second auxiliary magnet 183 are placed. Accordingly, in the recessed portions 181, the lines of magnetic force 42 pass obliquely with respect to the first radial direction 178, the second radial direction 179, and the circumferential directions 7.

In the recessed portions 181, the lines of magnetic force 42 pass obliquely with respect to the first radial direction 178, the second radial direction 179, and the circumferential directions 7, and the radii of curvature of the lines of magnetic force 42 passing from the first main pole magnet 174 to the first sub-pole magnet 175 are larger. The radii of curvature of the lines of magnetic force 42 passing from the first sub-pole magnet 175 to the second main pole magnet 176 are larger. In this regard, demagnetization of the first sub-pole magnet 175 may be suppressed even when the sub-pole magnet is affected by a magnetic field applied by the stator 173.

The second sub-pole magnet 177 has the same effect as the first sub-pole magnet 175. The radii of curvature of the lines of magnetic force 42 passing from the first main pole magnet 174 to the second sub-pole magnet 177 are larger. The radii of curvature of the lines of magnetic force 42 passing from the second sub-pole magnet 177 to the second main pole magnet 176 are larger. In this regard, demagnetization of the second sub-pole magnet 177 may be suppressed even when the sub-pole magnet is affected by the magnetic field applied by the stator 173.

### Tenth Embodiment

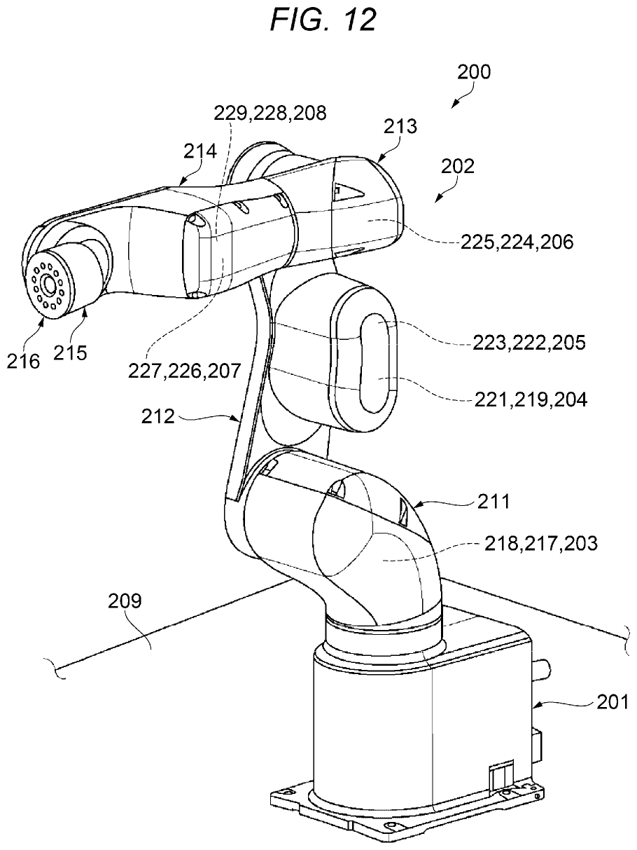

In the embodiment, a robot including the motor described in the first embodiment to the ninth embodiment will be explained. A robot 200 shown in FIG. 12 is used for respective work of e.g. transport, assembly, inspection, etc. of various workpieces (objects). The robot 200 has a base 201, a robot arm 202, and first drive unit 203 to sixth drive unit 208. The base 201 is mounted on a horizontal floor 209. Note that the base 201 may be mounted, not on the floor 209, but on a wall, a ceiling, a platform, or the like.

The robot arm 202 includes a first arm 211, a second arm 212, a third arm 213, a fourth arm 214, a fifth arm 215, and a sixth arm 216. An end effector (not shown) may be detachably attached to the distal end of the sixth arm 216, and gripping of a workpiece or the like may be performed using the end effector. The workpiece gripped by the end effector is not particularly limited to, but includes e.g. an electronic component and an electronic apparatus. In this specification, the base 201 side with reference to the sixth arm 216 is referred to as “proximal end side” and the sixth arm 216 side with reference to the base 201 is referred to as “distal end side”. The end effector is not particularly limited to, but includes a hand gripping a workpiece and a suction head suctioning a workpiece.

The robot 200 is a single-arm six-axis vertical articulated robot in which the base 201, the first arm 211, the second arm 212, the third arm 213, the fourth arm 214, the fifth arm 215, and the sixth arm 216 are sequentially coupled from the proximal end side toward the distal end side. Hereinafter, the first arm 211, the second arm 212, the third arm 213, the fourth arm 214, the fifth arm 215, and the sixth arm 216 may be respectively referred to as “arm”. The lengths of the first arm 211 to the sixth arm 216 are respectively not particularly limited, but can be appropriately set. Note that the number of arms of the robot arm 202 may be one to five, seven, or more. Or, the robot 200 may be a scalar robot or a dual-arm robot including two or more robot arms 202.

The base 201 and the first arm 211 are coupled via a first joint 217. The first arm 211 is pivotable around a pivot axis parallel to a vertical axis as a pivot center relative to the base 201. The first arm 211 pivots by driving of a first motor 218 and the first drive unit 203 having a reducer (not shown). The first motor 218 generates a drive force for pivoting the first arm 211.

The first arm 211 and the second arm 212 are coupled via a second joint 219. The second arm 212 is pivotable around a pivot axis parallel to a horizontal plane as a pivot center relative to the first arm 211. The second arm 212 pivots by driving of a second motor 221 and the second drive unit 204 having a reducer (not shown). The second motor 221 generates a drive force for pivoting the second arm 212.

The second arm 212 and the third arm 213 are coupled via a third joint 222. The third arm 213 is pivotable around an axis parallel to a horizontal plane as a pivot center relative to the second arm 212. The third arm 213 pivots by driving of a third motor 223 and the third drive unit 205 having a reducer (not shown). The third motor 223 generates a drive force for pivoting the third arm 213.

The third arm 213 and the fourth arm 214 are coupled via a fourth joint 224. The fourth arm 214 is pivotable around a pivot axis parallel to a center axis of the third arm 213 as a pivot center relative to the third arm 213. The fourth arm 214 pivots by driving of a fourth motor 225 and the fourth drive unit 206 having a reducer (not shown). The fourth motor 225 generates a drive force for pivoting the fourth arm 214.

The fourth arm 214 and the fifth arm 215 are coupled via a fifth joint 226. The fifth arm 215 is pivotable around a pivot axis orthogonal to a center axis of the fourth arm 214 as a pivot center relative to the fourth arm 214. The fifth arm 215 pivots by driving of a fifth motor 227 and the fifth drive unit 207 having a reducer (not shown). The fifth motor 227 generates a drive force for pivoting the fifth arm 215.

The fifth arm 215 and the sixth arm 216 are coupled via a sixth joint 228. The sixth arm 216 is pivotable around a pivot axis parallel to a center axis in the distal end portion of the fifth arm 215 as a pivot center relative to the fifth arm 215. The sixth arm 216 pivots by driving of a sixth motor 229 and the sixth drive unit 208 having a reducer (not shown). The sixth motor 229 generates a drive force for pivoting the sixth arm 216.

The rotary motor according to the above described respective embodiments is used for at least one of the first motor 218 to the sixth motor 229. That is, the robot 200 includes the rotary motor according to the above described respective embodiments.

According to the configuration, the first motor 218 to the sixth motor 229 of the robot 200 are rotary motors in which demagnetization may be suppressed even when the numbers of the magnetization directions 41 of the sub-pole magnets are smaller. Therefore, the robot 200 may be a robot including rotary motors in which demagnetization may be suppressed even when the numbers of the magnetization directions 41 of the sub-pole magnets are smaller.

### Eleventh Embodiment

In the rotor 171 of the above described ninth embodiment, the rotor 3 of the first embodiment is changed into a form of a radial gap motor. In addition, the rotor 58 of the second embodiment to the rotor 158 of the eighth embodiment may be changed into forms of radial gap motors. Also, in this case, the same effects as those of the respective embodiments may be obtained.

### Twelfth Embodiment

In the rotor 171 of the above described ninth embodiment, the first auxiliary magnet 182 to the fourth auxiliary magnet 185 are placed in the recessed portions 181. The fillers 85 may be placed in the recessed portions 181. Also, in this case, demagnetization may be suppressed in the rotor 171.

### Thirteenth Embodiment

In the tenth embodiment, the example in which the rotary motor according to the above described respective embodiments is used for the first motor 218 to the sixth motor 229 of the six-axis vertical articulated robot is shown. In addition, the first motor 218 to the sixth motor 229 may be applied to an apparatus including a motor such as a scalar robot, a machine tool, an automobile, an electric railcar, or a home appliance.

What is claimed is:

1. A rotary motor comprising:
a stator; and
a rotor rotating relative to the stator, wherein
the rotor has a first main pole magnet, a first sub-pole magnet, a second main pole magnet, and a second sub-pole magnet in contact with one another,
the first main pole magnet, the first sub-pole magnet, the second main pole magnet, and the second sub-pole magnet are sequentially repeatedly placed along a circumference of a rotation axis for relative rotation,
a magnetization direction of the first main pole magnet is a first direction from the stator toward the rotor,
a magnetization direction of the second main pole magnet is a second direction from the rotor toward the stator,
magnetization directions of the first sub-pole magnet and the second sub-pole magnet are circumferential directions from the first main pole magnet toward the second main pole magnet,
the first sub-pole magnet and the second sub-pole magnet have recessed portions in parts facing the stator and facing the first main pole magnet or the second main pole magnet, and
third magnets in magnetization directions different from the first direction, the second direction, or the circumferential directions or fillers containing a magnetic material are provided in the recessed portions.

2. The rotary motor according to claim 1, wherein
the third magnet is magnetized in a single direction.

3. The rotary motor according to claim 1, wherein
the third magnet is magnetized in a plurality of directions.

4. The rotary motor according to claim 1, wherein
the third magnet is formed using a plurality of magnets magnetized in different directions.

5. The rotary motor according to claim 1, wherein
the filler containing the magnetic material is putty containing a soft magnetic material or a magnetic fluid.

6. A robot comprising the rotary motor according to claim 1.
